(19) United States
(12) Patent Application Publication
(10) Pub. No.: US 2013/0082998 A1
(43) Pub. Date: Apr. 4, 2013

(54) DISPLAY DEVICE VOLTAGE GENERATION

(71) Applicant: Imre KNAUSZ, Fairport, NY (US)

(72) Inventor: Imre KNAUSZ, Fairport, NY (US)

(21) Appl. No.: 13/250,793

(22) Filed: Sep. 30, 2011

(51) Int. Cl. G06F 3/038; G05F 1/648

(52) U.S. Cl. 345/212; 323/297

(57) ABSTRACT

A voltage generator circuit comprises a resistor string, a drive mechanism configured to drive a drive signal, a voltage feedback network, and a voltage tap point. The voltage tap point is located along the resistor string. The voltage tap point is configured to be selectively coupled simultaneously with the drive mechanism and the voltage feedback network, such that an output of the voltage tap point is selectively coupled with the drive mechanism via the voltage feedback network.

### BACKGROUND

Liquid Crystal Display (LCD) devices and other display devices use a variety of techniques to generate voltages that correspond in some fashion to a gamma curve, which is a non-linear curve that maps pixel luminance values, such as pixel grey-level values, to drive voltage values.

### SUMMARY

A voltage generator circuit comprises a resistor string, a drive mechanism configured to drive a drive signal, a voltage feedback network, and a voltage tap point. The voltage tap point is located along the resistor string. The voltage tap point is configured to be selectively coupled simultaneously with the drive mechanism and the voltage feedback network, such that an output of the voltage tap point is selectively coupled with the drive mechanism via the voltage feedback network.

### BRIEF DESCRIPTION OF DRAWINGS

The drawings referred to in this Brief Description of Drawings should not be understood as being drawn to scale unless specifically noted. The accompanying drawings, which are incorporated in and form a part of the Description of Embodiments, illustrate various embodiments of the present invention and, together with the Description of Embodiments, serve to explain principles discussed below, where like designations denote like elements, and:

FIG. 1 illustrates three different gamma curves, according various embodiments;

FIG. 2 is a high level block diagram of an example display device, in accordance with various embodiments;

FIG. 3 illustrates an example gamma curve voltage generator circuit, according to various embodiments; and

FIG. 4 shows a flow diagram of an example method of controlling voltage generation, in accordance with various embodiments.

### DESCRIPTION OF EMBODIMENTS

The following Description of Embodiments is merely provided by way of example and not of limitation. Furthermore, there is no intention to be bound by any expressed or implied theory presented in the preceding technical field, background, brief summary or the following detailed description.

### Overview of Discussion

Herein, various embodiments and methods are described that facilitate improved usability of display devices and display device gamma voltage generator circuits. Discussion begins with description of some example gamma curves for a variety different display panels (e.g., Liquid Crystal Display panels). An example display device, which includes a display such as an LCD panel is then described. The display device includes a voltage generator circuit, some features of which are then described in greater detail. The voltage generator circuit is configured to generate gamma curve voltages which can be utilized for one or a variety of display panels. As will be describe the voltage generator circuit is configured to reduce voltage errors in gamma curve voltages by recusing errors in the drive signals that are driven on a resistor string of the voltage generator circuit. Operation of a voltage generator circuit is described in further detail in conjunction with description of controlling voltage generation.

### Example Gamma Curves for Display Devices

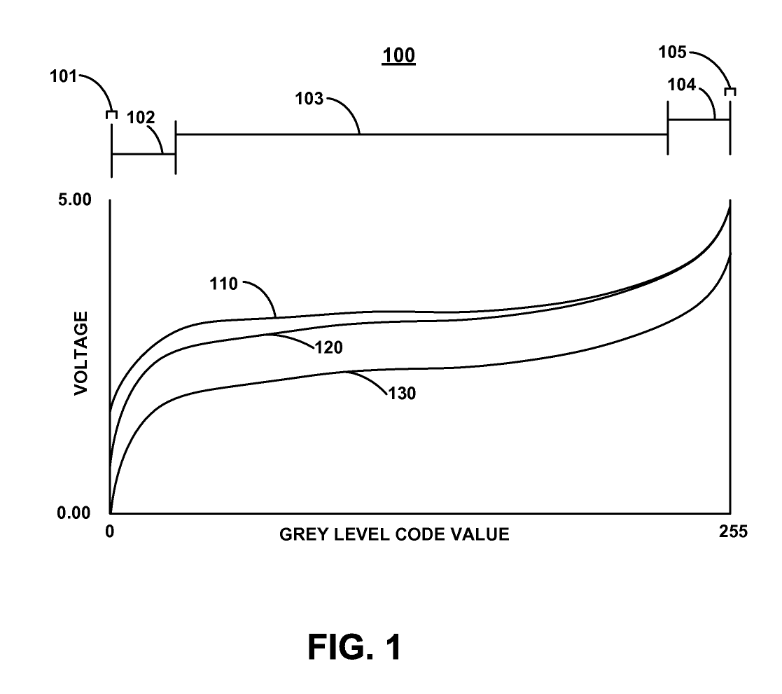

FIG. 1 illustrates gamma curves (110, 120, 130), according to various embodiments. In one embodiment, the three gamma curves are for three different display panels. In other embodiments, the three gamma curves may correspond to gamma curves for different colors of one display panel. Manufacturers typically supply gamma curves for use with their display panels. For example, in one embodiment: gamma curve 110 is a gamma curve for a display panel of manufacturer A; gamma curve 120 is for a gamma curve for a display panel of manufacturer B; and gamma curve 130 is a gamma curve for a display panel of manufacturer C. In one embodiment, a display panel of manufacturer A may have a red gamma curve, a green gamma curve and a blue gamma curve, where at least one may correspond to gamma curve 110. In another embodiment, a display panel of manufacturer B may have a red gamma curve, a green gamma curve and a blue gamma curve, where at least one may correspond to gamma curve 120. In a further embodiment, a display panel of manufacturer C may have a red gamma curve, a green gamma curve and a blue gamma curve, where at least one may correspond to gamma curve 130. In yet further embodiments, a display panel may have gamma curves corresponding to other colors. In other embodiments, a display panel may have more than three gamma curves, where each may correspond to a different color. In various embodiments, a display panel may have less than three gamma curves. The supplied gamma curves may be utilized to map input grey level values received by a display device to output drive voltage levels for the display panel that is employed in the display device.

In the embodiment illustrated in FIG. 1, even though gamma curves 110, 120, and 130 differ from one another, they have some common features related to their sigmoidial shape. All start at a lowest and fixed voltage at starting point 101 (starting voltages may differ from gamma curve to gamma curve). In initial region 102, each of the gamma curves experiences a rapid steeply sloped, and non-linear increase. In middle region 103, each of the gamma curves has a broad, gradually sloped response which encompasses the majority of the grey level code values and in which change is fairly linear. In end region 104, each of the gamma curves again has a steeply sloped, non-linear increase in voltage. The slope of end region 104 may be different than the slope of initial region 102 in some gamma curves. At ending point 105, each of the gamma curves ends at a highest and fixed voltage (ending voltages may differ from gamma curve to gamma curve). In other embodiments, gamma curves having other shapes are also possible. For example, the slope of region 102 may be more or less than the slope of region 103. Further, the slope of region 103 may be more or less than the slope of region 104. Various display devices may be very sensitive to small errors in voltage in certain portions of a gamma curve or across the entirety of a gamma curve. For example, a display device may be very sensitive to voltage changes across the shallow sloped region 103 of its gamma curve. Such sensitivity of a display device necessitates very accurate generation of voltages.

### Example Display Device

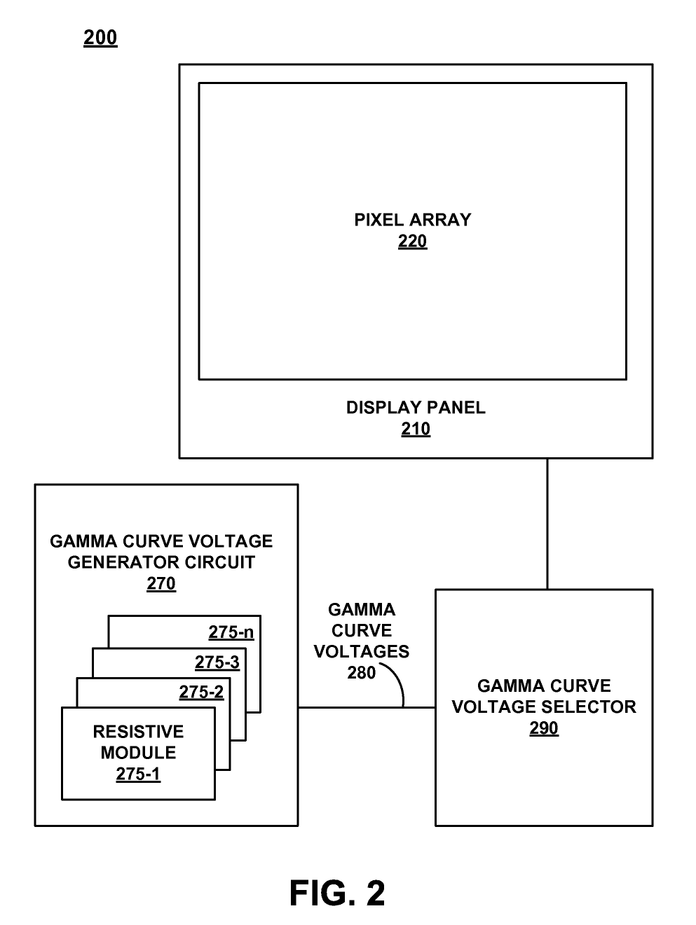

FIG. 2 is a high level block diagram of an example display device 200, in accordance with various embodiments. For purposes of example, and not of limitation, display device 200 is illustrated as containing gamma curve voltage generator circuit 270. In various embodiments, gamma curve voltage generator circuit 270 may comprise firmware and/or software in combination with circuitry. In one embodiment, gamma curve voltage generator circuit 270 comprises a linear resistor string 275 which may be a single continuous string or a string comprised of a plurality of resistive modules 275-1, 275-2, . . . 275-n. A plurality of gamma curve voltages are generated along the length of resistor string 275 by driving a particular drive signal at a selected location along resistor string 275. When resistor string 275 comprises a plurality of resistive modules, drive signals may be driven at selected locations within or between the resistive modules. When a plurality of resistive modules are utilized to form linear resistor string 275: a first resistive module 275-1 may generate a first plurality of gamma curve voltages in accordance with a first portion of a gamma curve, such as gamma curve 110; and a second resistive module 275-2 may be configured to generate a second plurality of gamma curve voltages in accordance with a second portion of a gamma curve, such as gamma curve 110. When a third resistive module 275-2 is included, it may be configured to generate a third plurality of gamma curve voltages in accordance with a third portion of a gamma curve, such as gamma curve 110. In various embodiments, each resistive module 275-1 to 275-n may comprise a linear resistor string. In the following description, a first resistive module comprising a linear resistor string may be referred to as a first linear resistor string; a second resistive module comprising a linear resistor string may be referred to as a second linear resistor string; and a third resistive module comprising a linear resistor string may be referred to as a third linear resistor string. In other embodiments, each resistive module 275-1 to 275-n may comprise a printed resistor with multiple tap points along its length, or other resistive device which can generate a plurality of resistances at a plurality of tap points. In some embodiments first and second resistive modules are described; however, in other embodiments, a gamma curve voltage generator circuit 270 may comprise more or less than two resistive modules in a resistor string 275. For example, there may be three, four, or more resistive modules, or there may be a single resistive module which makes up the entire resistor string 275. In one embodiment, resistive module 275-1 comprises a series-connected set of resistors of a first value of resistance; resistive module 275-2 comprises a series-connected set of resistors of a second value of resistance; resistive module 275-3 comprises a series-connected set of resistors of a third value of resistance; and resistive module 275-n comprises a series-connected set of resistors of a fourth value of resistance. One or more of the first, second third, and fourth resistance values may be the same or different.

In one embodiment, the gamma curve for which gamma curve voltages are generated may be selected from a set of gamma curves, for example gamma curve 110 may be selected from a plurality of gamma curves for a single display panel 210 (e.g., a red gamma curve for display panel 210, a blue gamma curve for display panel 210, a green gamma curve for display panel 210, etc.) and/or from a plurality of gamma curves for different displays (e.g., a red gamma curve for a display made by manufacturer A, a red gamma curve for a display made by manufacturer B, and a red gamma curve for a display made by manufacturer C, etc.). The selection may be based on the desired sub-pixel display color and/or the manufacturer. In other embodiments, a single gamma curve may be used. In further embodiments, the gamma curve may be hardwired within the circuitry and/or firmware of display device 200.

Gamma curve voltage selector 290 is configured to select a first gamma curve voltage from a set of gamma curve voltages 280 that comprise the plurality of gamma curve voltages, the second plurality of gamma curve voltages, and additional pluralities of gamma curve voltages when more than two resistive modules 275-1 to 275-n are utilized to form a resistor string 275. Gamma curve voltage selector 290 is further configured to couple the first gamma curve voltage with a respective pixel of pixel array 220 in display panel 210. The first and second pluralities of gamma curve voltages correspond to first and second subsets of a set of grey-level values. In one embodiment, the overall set of grey-level values may comprise 256 values. In other embodiments, different amounts of values may be used. In various embodiments, the grey-level values may be based on a grey-level code. For example, the 256 grey-level values may be based on an 8-bit grey-level code values. In other embodiments, other numbers of code values may be used.

In one embodiment, gamma curve voltage generator circuit 270, and corresponding resistive modules 275-1 to 275-n generate a different set of reference gamma curve voltages for each different gamma curve. In one embodiment, each sub-pixel color may have a corresponding gamma curve; for example, in one embodiment, a red gamma curve corresponding to red sub-pixels, a green gamma curve corresponding to green sub-pixels, and a blue gamma curve corresponding to blue sub-pixels. In another embodiment, a red gamma curve corresponding to red sub-pixels, a green gamma curve corresponding to green sub-pixels, a blue gamma curve corresponding to blue sub-pixels and a white gamma curve corresponding to white sub-pixels. In other embodiments, different display device manufacturers may have corresponding gamma curves. In yet further embodiments, each display device manufacture may have a gamma curve corresponding to each sub-pixel color. The gamma curves may be stored within a storage device, and may be selected based on the display device manufacturer and/or sub-pixel color to be displayed. In one embodiment, gamma curve voltage generator circuit 270 selects the gamma curve for which voltages are to be generated. In other embodiments, the gamma curve is selected externally from gamma curve voltage generator circuit 270 and communicated to gamma curve voltage generator circuit 270. External selection can take place at various times and locations. For example, in one embodiment, external selection of a gamma curve occurs as a part of manufacture of a display device 200. In another embodiment, gamma curve selection can occur just prior to generating gamma curve voltages during operation of display device 200.

In various embodiments, gamma curve voltage selector 290 is configured to select a gamma curve voltage 280 corresponding to the sub-pixel color to be displayed by display device 200. In one example embodiment, where there are 256 grey-level values, a gamma curve voltage selector 290 connects exactly one of these voltages to an associated pixel, according to the 8-bit value for that pixel's red, green or blue sub-pixel. Note that a given gamma curve voltage 280 output from gamma curve voltage generator circuit 270 may be connected to none of the pixels or to any number of the pixels. This depends on the sub-pixel data

### Example Voltage Generator Circuit

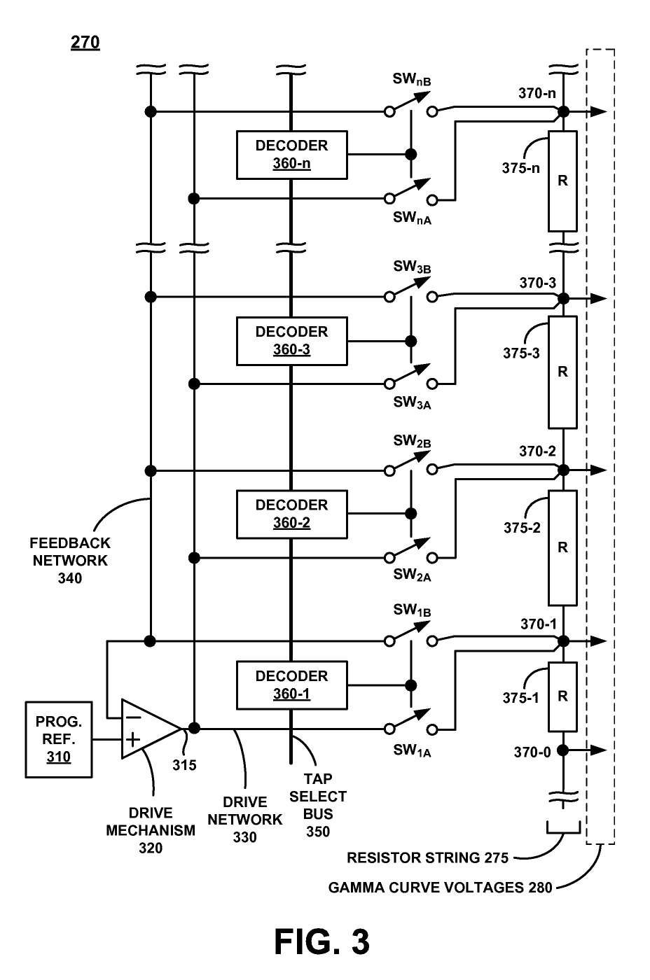

FIG. 3 illustrates an example voltage generator circuit 270, according to various embodiments. Circuit 270 may be utilized to generate gamma curve voltages. In discussion of FIG. 3, reference is made to components of FIG. 2. In some embodiments, gamma curve voltage generator circuit 270 is coupled with or disposed within a display driver ASIC (Application Specific Integrated Circuit) of a display device 200. It should be appreciated that circuit 270 is greatly simplified in order to more clearly illustrate circuitry and techniques for controlling errors in the generation of voltages by controlling errors in the drive signals that are driven onto resistor string 275.

Many factors may contribute to voltage errors when generating gamma curve voltages 280. Some of these factors include, but are not limited to: current draw of the load (display), current draw of the resistor string, resistances in the drive network over which a drive signal travels to drive a tap point (e.g., parasitic resistances of the wiring route that are in the route of the drive signal, resistances of switches that are the route of the drive signal, and other route resistances such as the resistance of vias that are in the route of the drive signal). The various resistances in the drive network may cause significant voltage errors in a tapped gamma curve voltage 280 due to significant IR drops. As many display devices can be very sensitive to variations in the supplied gamma curve voltage, circuit 270 utilizes a particularized form of feedback control to control the level of drive signal 315 at (or very close to) the tap point where drive signal 315 is driven onto resistor string 275. This feedback allows for controlling drive signal error at the tap point where the drive signal is applied to resistor string 275.

With reference to FIG. 3 and to circuit 270, in the illustrated embodiment, resistor string 275 comprises a series connected set of resistors. In one embodiment, resistor string 275 may correspond to at least a portion of a resistive module (i.e., a resistive module of resistor modules 275-1 . . . 275-n). In such an embodiment, resistive string 275 comprises a series-connected set of resistive modules and or resistors. A voltage tap point 370-0 is ohmically coupled to a first of two ends of resistor 375-1. The second end of resistor 375-1 is ohmically coupled to one of the two ends of resistor 375-2. The second of the two ends of resistor 375-2 is ohmically coupled to a first of two ends of resistor 375-3. The second end of resistor 375-3 is ohmically coupled with a first of two ends of resistor 375-n. The second of two ends of resistor 375-n is coupled with voltage tap point 370-n. In a similar fashion, additional resistors to those illustrated may be included in series as portions of resistor string 275.

Voltage tap points may be referred to generically herein as “tap points” or as “voltage tap points.” Even though either a voltage or current may be driven onto resistor string 275 via the voltage tap point, a gamma curve voltage 280 may be tapped at the voltage tap point regardless of whether a voltage or current drive signal 315 is driven. This is because resistor string 275 creates a plurality of tappable gamma curve voltages 280 whether driven by voltage or current.

In various embodiments, each voltage tap point 370 (370-0-370-n) is configured to be programmably selected to couple simultaneously with drive mechanism 320 and with voltage feedback network 340. In one embodiment, various voltage tap points may be fixed, such as voltage tap points at either end of resistor string 275. In various embodiments, a voltage tap point is programmably selected based on corresponding gamma curve voltages. For example, a voltage tap point of voltage tap points 370 may be programmably selected to output a gamma curve voltage or plurality of gamma curve voltages based on the gamma curve (i.e., gamma curve 110, 120, 130). In various embodiments, as the gamma curve changes, the voltage tap point programmably selected changes correspondingly.

A programmable reference 310, which is either a reference voltage or a reference current, is utilized to set the level of drive signal 315 (either a drive voltage or a drive current) which is driven by drive mechanism 320. The value of programmable reference 310 may be programmably altered during the operation of circuit 270 in order to alter the level of a voltage or current that is being driven as drive signal 315.

Drive mechanism 320 utilizes feedback control. This can be implemented in various manners. As illustrated, drive mechanism 320 is implemented as differential operational amplifier with feedback control. Drive mechanism 320 drives a signal based on a level of a programmable reference which is supplied as an input. Drive mechanism 320 may amplify the programmable reference 310 or may have its gain set such that it simply attempts to buffer the level of the programmable reference 310 as drive signal 315. The output of drive mechanism 320 may be a drive signal 315 that is either a voltage or a current, depending on the configuration of circuit 270. Drive signal 315 is coupled onto drive network 330 from the output of drive mechanism 320.

Tap select bus 350 and a decoder 360 (decoders 360-1, 360-2, 360-3, 360-n illustrated) operate to selectively open and close switches SW_{1A}, SW_{2A}, SW_{3A}, to SW_{nA} to couple drive network 330 either to no voltage tap point, or to only a single voltage tap point during any period of time. For example, if switch SW_{1A} is closed, switches SW_{2A}, SW_{3A}, and SWnA are open. Switch SW_{1B} corresponds to switch SW_{1A}, and decoder 360-1 opens and closes switch SW_{1A} and SW_{1B} in concert with one another such that SW_{1A} and SW_{1B} are closed simultaneously and opened simultaneously. In a similar fashion decoder 360-2 operates switches SW_{2A} and SW_{2B} in concert; decoder 360-3 operates switches SW_{3A} and SW_{3B} in concert; and likewise decoder 360-n operates switches SW_{nA} and SW_{nB} in concert. Although separate decoders 360-1, 360-2, 360-3 . . . 360-n are illustrated with respect to the switches associated with each of voltage tap points 370-1, 370-2, 370-3 . . . 370-n, it is appreciated that other addressing schemes may be utilized. For example, signals may be multiplexed to switches SW_{1A}-SW_{nA} and to switches SW_{1B}-SW_{nB}. Additionally, other decoding mechanisms and/or configurations may be utilized. For example, a tree decoder may be utilized.

When switch SW_{1B} is closed in concert with the closing of SW_{1A}, voltage tap point 370-1 is coupled with feedback network 340 which couples a voltage that is output from voltage tap point 370-1 to the inverting input of drive mechanism 320. This voltage feeds back information about the actual level of drive signal 315 when it reaches voltage tap point 370-1. When switch SW_{2B} is closed in concert with the closing of SW_{2A}, voltage tap point 370-2 is coupled with feedback network 340 which couples a voltage that is output from voltage tap point 370-2 to the inverting input of drive mechanism 320. This voltage feeds back information about the actual level of drive signal 315 when it reaches voltage tap point 370-2. When switch SW_{3B} is closed in concert with the closing of SW_{3A}, voltage tap point 370-3 is coupled with feedback network 340 which couples a voltage that is output from voltage tap point 370-3 to the inverting input of drive mechanism 320. This voltage feeds back information about the actual level of drive signal 315 when it reaches voltage tap point 370-3. When switch SW_{nB} is closed in concert with SW_{nA}, voltage tap point 370-n is coupled with feedback network 340 which couples a voltage that is output from voltage tap point 370-n to the inverting input of drive mechanism 320. This voltage feeds back information about the actual level of drive signal 315 when it reaches voltage tap point 370-n. It is appreciated that circuit 270 may couple a first voltage tap point, such as voltage tap point 370-1, simultaneously with drive network 330 and feedback network 340 for a first period of time and then switch to coupling a second voltage tap point, such as voltage tap point 370-2, simultaneously with drive network 330 and feedback network 340 during a subsequent and non-overlapping period of time.

Consider the following non-limiting example of one possible operation of circuit 270. For purposes of this example only, programmable reference 310 is programmed to provide 2.3V at the non-inverting input of drive mechanism 320. Drive mechanism 320 is configured as a buffering amplifier with feedback, and initially outputs a drive signal 315 of 2.3V onto drive network 330. Decoder 360-1 decodes information from voltage tap select bus 350 that causes it to close switch SW_{1A}, which allows drive mechanism 320 to drive a drive signal 315 through drive network 330 and onto voltage tap point 370-1. Simultaneously, to closing switch SW_{1A}, decoder 360-1 also closes switch SW_{1B}. This provides a feedback path from voltage tap point 370-1 to the inverting input of drive mechanism 320. This is a voltage feedback path as the input to the drive mechanism 320 has a practically infinite DC input impedance, and thus no current in the path regardless of the resistive elements in the path. Because there is no current flow, no additional errors are induced by feedback network 340. The feedback voltage provides a snapshot of the level of drive signal 315 that actually reaches voltage tap point 370-1. For example, drive signal 315 may have been reduced to a level of 2.25V due one or more resistances that exist in drive network 330 between the output of drive mechanism 320 and voltage tap point 370-1. Some non-limiting examples of these resistances which can induce error into drive signal 315 include: wiring resistance, resistance of one or more switches, and a routing resistance (e.g., resistance due to vias and other items in the route that drive signal 315 travels between drive mechanism 320 and voltage tap point 370-1). Based on this voltage feedback from voltage tap point 370-1, drive mechanism 320 adjust the level of its output so that a drive signal 315 of 2.3V actually arrives at voltage tap point 370-1. For example, based on continuous feedback via feedback network 340, drive mechanism 320 may eventually output a drive signal 315 such as 2.35V in order to overcome errors in drive network 330 to achieve a drive signal 315 of 2.3V at voltage tap point 370-1. This reduces, and in this example nullifies, the error(s) introduced into drive signal 315 by drive network 330.

### Example Method of Controlling Voltage Generation

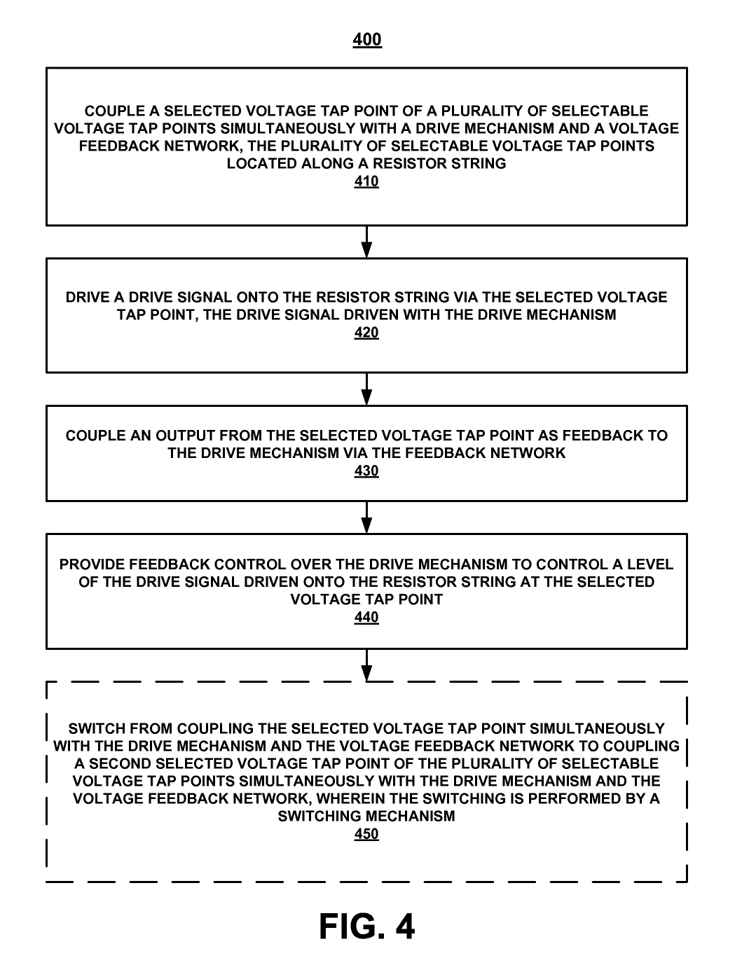

FIG. 4 illustrates a flow diagram of an example method of controlling voltage generation, in accordance with various embodiments. For purposes of illustration, during the description of flow diagram 400, reference will be made to features illustrated in one or more of FIGS. 1-3. In some embodiments, not all of the procedures described in flow diagram 400 are implemented. In some embodiments, other procedures in addition to those described may be implemented. In some embodiments, procedures described in flow diagram 400 may be implemented in a different order than illustrated and/or described.

At 410 of flow diagram 400, in one embodiment, a selected voltage tap point of a plurality of selectable voltage tap points is coupled simultaneously with a drive mechanism and a voltage feedback network, said plurality of selectable voltage tap points located along a resistor string. This coupling is performed by a switching mechanism. The switching mechanism may comprise switches which are selectively addressed/controlled, such as with decoder logic, multiplexed signals, or the like. With reference to FIG. 3, this may comprise appropriate signals on tap select bus 350 which cause decoder logic 360 (decoder 360-1) to close switches SW_{1A} and SW_{1B} such that voltage tap point 370-1 is coupled simultaneously with drive network 330 via SW_{1A} and with feedback network 340 via SW_{1B}.

At 420 of flow diagram 400, in one embodiment, a drive signal is driven onto the resistor string via the selected voltage tap point. The drive signal is driven with the drive mechanism and can be either a voltage drive signal or a current drive signal. The drive mechanism can utilize a programmable reference voltage (or current) as in input for determining a voltage to drive onto the resistor string. The programmability allows different drive signal levels (e.g., different voltage levels or different current levels) to be programmably selected for driving onto a resistor string. For example, with reference to FIG. 3, drive mechanism 320 may be configured as either a feedback amplifier or buffer with feedback and can be used to drive a drive signal 315 through drive network 330 and via SW_{1A} onto resistor string 275 at voltage tap point 370-1. The level of drive signal 315 is selected by selecting the level of the programmable reference which is coupled as an input to drive mechanism 320.

At 430 of flow diagram 400, in one embodiment, an output is coupled from the selected voltage tap point as feedback to the drive mechanism via the feedback network. The output is a voltage and is the same as a gamma curve voltage 280 that may be tapped from this voltage tap point by a gamma curve voltage selector 290. For example, with reference to FIG. 3, when a signal is driven onto voltage tap point 370-1 via drive network 330 and through SW_{1A}, a voltage is coupled back to the non-inverting input of drive mechanism 320 through SW_{1B} via feedback network 340.

At 440 of flow diagram 400, in one embodiment, feedback control is provided over the drive mechanism to control a level of the drive signal driven onto the resistor string at the selected voltage tap point. For example, as illustrated, drive mechanism 320 is set up as a differential amplifier and utilizes the voltage fed back from a voltage tap point, such as voltage tap point 370-1 as feedback to adjust the level of drive signal 315 until the signals at the inverting and non-inverting inputs equate to one another. It is appreciated that a feedback voltage can be converted to a current, if current feedback is required by drive mechanism 320. This feedback control reduces an error in the drive signal at the tap point. The errors that are reduced may be from one or some combination of sources and may include errors due to one or more of a wiring resistance, a switch resistance, and a routing resistance.

At 450 of flow diagram 400, in one embodiment, further comprises switching from coupling the selected voltage tap point simultaneously with the drive mechanism and the voltage feedback network to coupling a second selected voltage tap point of the plurality of selectable voltage tap points simultaneously with the drive mechanism and the voltage feedback network. The switching is performed by a switching mechanism, such as a plurality of addressable switches. For example, with reference to FIG. 3, circuit 270 may couple a first voltage tap point, such as voltage tap point 370-1, simultaneously with drive network 330 and feedback network 340 for a first period of time. Circuit 270 may then receive information via tap select bus 350 which causes circuit 270 to couple a second voltage tap point simultaneously with drive network 330 and feedback network 340 during a subsequent and non-overlapping period of time. With respect to FIG. 3, the second voltage tap point may be any one of voltage tap point 370-2, voltage tap point 370-3, or voltage tap point 370-n. Depending on whether programmable reference 310 is changed or not, the drive signal 315 that is driven to the second voltage tap point may have the same level as the drive signal that was coupled with the first voltage tap point, the drive signal coupled to the second voltage tap point may have a different level from the drive signal that was coupled with the first voltage tap point.

The embodiments and examples set forth herein were presented in order to best explain the present invention and its particular application and to thereby enable those skilled in the art to make and use the invention. However, those skilled in the art will recognize that the foregoing description and examples have been presented for the purposes of illustration and example only. The description as set forth is not intended to be exhaustive or to limit the invention to the precise form disclosed.

What is claimed is:

1. A voltage generator circuit, said circuit comprising:
a resistor string;
a drive mechanism configured to drive a drive signal;
a voltage feedback network; and
a voltage tap point located along said resistor string, wherein said voltage tap point is configured to be selectively coupled simultaneously with said drive mechanism and said voltage feedback network, such that an output of said voltage tap point is selectively coupled with said drive mechanism via said voltage feedback network.

2. The circuit of claim 1, further comprising:
a switching mechanism, wherein said switching mechanism is configured to selectively couple said voltage feedback network with said voltage tap point, such that said output of said voltage tap point is selectively coupled with said drive mechanism via said voltage feedback network.

3. The circuit of claim 1, further comprising:
a second voltage tap point located along said resistor string, wherein said second voltage tap point is configured to be selectively coupled simultaneously with said drive mechanism and said voltage feedback network; and
a third voltage tap point located along said resistor string, wherein said third voltage tap point is configured to be selectively coupled simultaneously with said drive mechanism and said voltage feedback network.

4. The circuit of claim 1, further comprising:
a plurality of voltage tap points located along said resistor string, wherein said plurality of voltage tap points comprises said voltage tap point and wherein each voltage tap point of said plurality of voltage tap points is configured to be programmably selected to couple simultaneously with said drive mechanism and said voltage feedback network.

5. The circuit of claim 1, wherein said drive mechanism is configured to programmably drive said drive signal at a programmed level.

6. The circuit of claim 1, wherein said drive mechanism is configured to drive said drive signal onto said resistor string via said voltage tap point, and wherein a level of said drive signal at said voltage tap point is adjusted based on said output of said voltage tap point.

7. The circuit of claim 6, wherein said level of said drive signal at said voltage tap point is adjusted, based on said output of said voltage tap point, to reduce an error attributable to at least one of a wiring resistance, a switch resistance, and a routing resistance.

8. The circuit of claim 1, wherein said drive signal is one of a voltage drive signal and a current drive signal.

9. A method of controlling voltage generation, said method comprising:
coupling a selected voltage tap point of a plurality of selectable voltage tap points simultaneously with a drive mechanism and a voltage feedback network, said plurality of selectable voltage tap points located along a resistor string;
driving a drive signal onto said resistor string via said selected voltage tap point, said drive signal driven with said drive mechanism;
coupling an output from said selected voltage tap point as feedback to said drive mechanism via said feedback network; and
providing feedback control over said drive mechanism to control a level of said drive signal driven onto said resistor string at said selected voltage tap point.

10. The method as recited in claim 9, further comprising:
switching from coupling said selected voltage tap point simultaneously with said drive mechanism and said voltage feedback network to coupling a second selected voltage tap point of said plurality of selectable voltage tap points simultaneously with said drive mechanism and said voltage feedback network, wherein said switching is performed by a switching mechanism.

11. The method as recited in claim 9, wherein said providing feedback control over said drive mechanism to control said level of said drive signal driven onto said resistor string at said selected voltage tap point, comprises:
providing feedback control over said drive mechanism to control said level of said drive signal driven onto said resistor string at said selected voltage tap point, such that said level of said drive signal is adjusted, based on said output of said voltage tap point, to reduce an error attributable to at least one of a wiring resistance, a switch resistance, and a routing resistance.

12. The method as recited in claim 9, wherein said driving a drive signal onto said resistor string via said selected voltage tap point further comprises:
driving one of a voltage drive signal and a current drive signal onto said resistor string via said selected voltage tap point.

13. The method as recited in claim 9, wherein said driving a drive signal onto said resistor string via said selected voltage tap point, said drive signal driven with said drive mechanism comprises:
programmably driving said drive signal onto said resistor string with said drive mechanism.

14. A display device, said display device comprising:
a voltage generator circuit comprising:
a resistor string;
a drive mechanism configured to drive a drive signal;
a voltage feedback network; and
a voltage tap point located along said resistor string, wherein said voltage tap point is configured to be selectively coupled simultaneously with said drive mechanism and said voltage feedback network, such that an output of said voltage tap point is selectively coupled with said drive mechanism via said voltage feedback network;
a gamma curve voltage selector configured to select a gamma curve voltage from a set of gamma curve voltages available along said resistor string; and
a pixel array, wherein said gamma curve voltage selector is further configured to couple said selected gamma curve voltage with a respective pixel of said pixel array.

15. The display device of claim 14, wherein said voltage generator circuit further comprises:
a switching mechanism, wherein said switching mechanism is configured to selectively couple said voltage feedback network with said voltage tap point, such that said output of said voltage tap point is selectively coupled with said drive mechanism via said voltage feedback network.

16. The display device of claim 14, wherein said voltage generator circuit further comprises:
a second voltage tap point located along said resistor string, wherein said second voltage tap point is configured to be selectively coupled simultaneously with said drive mechanism and said voltage feedback network; and
a third voltage tap point located along said resistor string, wherein said third voltage tap point is configured to be selectively coupled simultaneously with said drive mechanism and said voltage feedback network.

17. The display device of claim 14, wherein said voltage generator circuit further comprises:
a plurality of voltage tap points located along said resistor string, wherein said plurality of voltage tap points comprises said voltage tap point and wherein each voltage tap point of said plurality of voltage tap point is configured to be programmably selected to couple simultaneously with said drive mechanism and said voltage feedback network.

18. The display device of claim 14, wherein said drive mechanism is configured to drive said drive signal onto said resistor string via said voltage tap point, and wherein a level of said drive signal at said voltage tap point is adjusted based on said output of said voltage tap point.

19. The display device of claim 18, wherein said level of said drive signal at said voltage tap point is adjusted, based on said output of said voltage tap point, to reduce an error attributable to at least one of a wiring resistance, a switch resistance, and a routing resistance.

20. The display device of claim 14, wherein said drive signal is one of a voltage drive signal and a current drive signal.
